(19) United States
(12) Patent Application Publication
(10) Pub. No.: US 2012/0317217 A1
(43) Pub. Date: Dec. 13, 2012

(54) METHODS AND SYSTEMS FOR MANAGING VIRTUAL IDENTITIES

(75) Inventors: Hanan Lavy, Tel-Aviv (IL); Alexander Burd, Pardes Hana (IL); Elisha Shaish, Nahariya (IL); Keren Liran, Tel-Aviv (IL); Dror Zernik, Tel-Aviv (IL)

(73) Assignee: United Parents Online Ltd., Tel-Aviv (IL)

(21) Appl. No.: 13/579,951

(22) PCT Filed: Feb. 17, 2011
(86) PCT No.: PCT/IL11/00166

§ 371 Date: Aug. 20, 2012

Related U.S. Application Data
(63) Continuation-in-part of application No. PCT/IL10/00495, filed on Jun. 22, 2010.
Application No. PCT/IL10/00495 is a continuation-in-part of application No. 12/534,129, filed on Aug. 2, 2009.
Application No. 12/534,129 is a continuation-in-part of application No. PCT/IB10/50329, filed on Jan. 26, 2010.
Application No. PCT/IB10/50329 is a continuation of application No. 12/534,129, filed on Aug. 2, 2009.
(60) Provisional application No. 61/305,557, filed on Feb. 18, 2010.
(60) Provisional application No. 61/392,203, filed on Oct. 12, 2010.
(60) Provisional application No. 61/427,805, filed on Dec. 29, 2010.
(60) Provisional application No. 61/218,998, filed on Jun. 22, 2009.
(60) Provisional application No. 61/305,557, filed on Feb. 18, 2010.
(60) Provisional application No. 61/218,998, filed on Jun. 22, 2009.
(60) Provisional application No. 61/218,998, filed on Jun. 22, 2009.

(51) Int. Cl. G06F 15/16

(52) U.S. Cl. 709/206; 709/224

(57) ABSTRACT

A method of monitoring a plurality of user generated interaction sessions. The method comprises providing a list of a plurality of defined users, where each defined user is associated with at least one response to a user-application interaction of a respective defined user with one of a plurality of defined applications accessible via a client terminal, identifying a current user of the client terminal from the plurality of defined users and at least one current interacted application from the plurality of defined applications, selecting a at least one respective response according to the at least one current interacted application and the current user, and triggering the at least one respective response.

This application claims priority from U.S. Provisional Patent Application No. 61/305,557, filed on Feb. 18, 2010; International Patent Application No. PCT/IL2010/000495 filed 22 Jun. 2010; and U.S. Provisional Patent Application No. 61/392,203 filed on 12 Oct. 2010, and the Provisional Patent Application No. 61/427,805 filed in 29 Dec. 2010.

The contents of all of the above documents are incorporated by reference as if fully set forth herein.

### FIELD AND BACKGROUND OF THE INVENTION

The present invention, in some embodiments thereof, relates to methods and systems for consistently monitoring, grouping and identifying computer users and their partner by providing a matching from multiple ‘virtual identities’ into either a real-life person, or into a single virtual identity. In some of the typical embodiments the system is used in one or both of two ways: on a local computer, the mentioned matching system decides, or matches the current user with one of the variety of people who have access to the computer. The second usage is similar for remote virtual identities. In this usage each interaction of a virtual identity with any local user is matched into a single ‘virtual personality’ or an ‘anchor-personality’. This allows for overcoming the multiple identities that people commonly use over the web during social interactions such as Instant Messaging and Social Networks (jointly referred to as Social Messaging), and ensuring the accurate identification of ‘virtual personalities’.

### SUMMARY

The present invention, in some embodiments thereof, describes methods and systems for consistently managing the identities of computer users during computer-human interaction and also when using the computer for person-to-person interactions. Some of the description will focus on an exemplary user-interaction monitoring system, but the present invention is not limited to this system.

Often there are two types of “persons” that are managed by such a system. The first type includes the variety of people who, each, use multi applications and multi virtual personalities (virtual identities) on the currently monitored computer. For these users the system can be used to associate almost all of the operation and match a virtual personality with one of the set of “real-life-persons” that are assumed to use the computer (or other similar device). The second type of persons includes remote participants in person-to-person interactions. In such an interaction the system can be used to manage and identify the identities and ‘personalities’ of the partners, the friends and chat buddies of the local users over the Internet. The system can be used also for only one of these functions, either remote or local identity management.

For both types of usage, the system deployment can be implemented either as a local system, or as a global one or as a distributed system.

By providing this identity resolution method many of the challenges of monitoring applications are resolved, even without the need to tightly impose user-login, or other strong authentication. The system, though, can co-exist with these authentication and access control methods and complement them.

The present invention, in some embodiments thereof, provides a potentially (end-user) invisible identity management service. Invisibility to the end-user here implies that no explicit access control is required by the computer users, and no feedback is necessarily provided to the end-user. At the same time, subscribers, or system operators, or other users may assist the system, or accelerate the decision about identity matching, but the system can deduce identities automatically. The identities that the system manages are mostly virtual identities, for example: login names, nicknames, email accounts, and “current user”, at each given moment. It is desired that each of these virtual identities be resolved, either into another “virtual identity”, or into a real-life person, relying on an authentication of the real-life person. For child protection the identity management may be fully successful even without any resolution into real-life people. When the above mapping is not to a real-life person, but rather to a virtual identity, it is referred to as an “anchor virtual identity”. An example of such a set of virtual identities that are mapped into an anchor virtual identity is when a local user interacts with what the local user knows to be “the same person”. However, since the interaction takes place over multiple communication channels, there is a virtual identity in each of these channels. The current user may interact with the remote person using email (first identity), chat (second identity) and social network (third identity). Naturally, the remote person may have multiple emails, multiple chat nicknames, and so on. The system maps these nicknames that have been resolved into a single “virtual person”. Only if the local user or some other external service informs the system about the “real-life-personality” that the local user interacts with, can this additional mapping be completed. In some cases, this person is known to the person, and thus is mapped, at least logically in the user's mind, to a “real-life person”. Grouping all the virtual identities into a single name P is the process of identity management of mapping virtual identities into an anchor virtual identity.

Participants or other system users (such as an administrator, or a guardian, for example) can provide information about themselves or about other participants, and this may be used to expedite the deduction process, but in some embodiments the system proceeds and generates the desired associations without human intervention. This is especially relevant for remote participants where a subscriber may not necessarily differentiate between what appears to be almost similar (name-wise) identities or unify multiple identities.

The associated identity is referred to as a ‘personality’. Accordingly, in some embodiments, the system provides mapping from virtual identities into personalities. Based on the decided ‘personality’, the current invention, in some embodiments thereof, allows for enforcing various content-management policies and access control policies, without having to enforce explicit identification for every content element accessed or for every application used.

An example of such a content access monitoring and control is for home computers, where no “user-login” is enforced. Still, using the current system access to adult content can be prevented from children. This can be achieved based on the system's decision that the child is the ‘current user’, and the content is tagged as “adult content”. Tagging content is provided by several companies, such as BlueCoat Inc, eSoft Inc and several others. These content taggers and filters allow for both categorizing the access paged (before it is displayed) and then if so decided, enforcing the desired access-control policy.

Knowing the identity the current user may be useful, for example, for identity-theft prevention, as can be seen in the following example: once the Identity Management System (IMS) created an accurate enough profile of a user X, when a user Y tries to access X's account on some communication system, the IMS immediately detects the differences, using the acquired identification parameters and controls this access as planned by the access control sub-system which interacts with the IMS. (Typically, the desired action will be to either suspend, prevent, block, notify or any other action as desired

Another example of using the knowledge about “current-user's” identity is to allow or prevent some operations on the local computer. This may include preventing access to unidentified operations. (E.g. Word, Excel.)

In an exemplary embodiment of the invention, the association of identities to a personality is based on one or more of matching behavioral, character and/or lingual patterns on top of known methods (such as device reputations, for example). Additionally or alternatively, cross application identification can be done, that is, based on the user logging into a social network (such as Facebook), the system may deduce that the immediately following interaction with a word document is performed by the same user, and hence, the current-user is assumed to be the same social-network user.

The system, in some embodiments thereof, tracks people's unique computer usage patterns, and then forms lingual and personality fingerprints. This may be independent of the device they are using (computer, or other communication device, be it local or remote) and without assuming some additional access control software or explicit identity management membership, or explicit third party service, such as web-site, where device-reputation can be used.

Device reputation methods can be co-used with the current system. However, device reputation techniques typically rely on HTTP protocol, where interaction between the (browser) client and the server is available, and the service is centralized. In IM and other typical social networks applications, the communication is not necessarily with the central service, but rather point to point. Further, device reputation is often used to form a ‘black-list’; a list of suspected devices. This is due to the nature of the offense that they try to block. In the cases that a computer program is used to break into multiple accounts, device reputation methods should or may be deployed together with the current method. However, in many of the identity theft cases, the thief is looking for a specific victim, and then device reputation methods are less applicable The suggested Identity Management System (IMS) gathers a different set of parameters; these parameters are available over IM protocol and may include in some embodiments each participant's unique vocabulary, the types of spelling mistakes which are unique to the person, typing speed, and content related parameters.

On personal computers, and especially on corporate computers it is commonly required to base user-identification and authentication on ‘login-password’ access control, or sometimes also biometric user-authentication and this is the case also in some private computers. However, once a user passed this authentication the user can access multiple ‘virtual personalities’ and applications, and there is sometimes a desire to associate these virtual identities with the single ‘real-life user’.

Further, even if a user-password protection is provided for computer/device access control, in many cases, even in workplaces, a single login is used, and multiple users use the same ‘account’ during a work-day. Accordingly, in order to provide personalized services, and to be able to uniquely monitor and associate most activity with an identified personality, a system and method are described, which allow for mapping computer-based (virtual) personalities continuously and in real-time, into real-life people.

Another challenge when monitoring various personalities, addressed by some embodiments of the invention, is the privacy issue. On a local machine, it may be the case that some of the users need to be monitored, while others need not be monitored, as is the typical case when monitoring a personal computer used by a family. It is desired that only the minors under the parent supervision are monitored, and any other user is not monitored. However, it is desired that buddies (chat partners and social network friends) of these people that are monitored locally are identified as well. This is desired to provide security services for the people using the terminal, to prevent fraud-based dialogues, and on-line attacks on people and kids. Accordingly, a person that is not monitored on the local machine, but is interacting with a monitored buddy over the web, may sometimes be identified by the monitoring services provided to the other, remote party.
Examples of virtual identities on a local computer include: The Windows/Operating system user name (login name);
Any Internet service where the user is required to provide identification, such as mail server, social network, Instant Message engines, gaming, banking, online shopping, and similar remote, identified applications.
Locally ‘protected applications’, where the users are required to provide their credentials in order to gain access to or perform the operation. Mail clients such as Microsoft's Outlook™ or Internet phones are examples for such applications.
Chat partners that are identified only by their nicknames, at least from the perspective of the local user.

On remote interactions, virtual identities typically include all of the names and identification that the local user is exposed to. This typically includes
Names (not necessarily unique) within a social network
A unique numeral, or alpha-numeral identifier within an Instant Messaging network and
E-mails within one or more mail providers.

Ideally, the Identity Management System (IMS) would monitor and resolve all of the above identities, both local and remote. However, a partial list is often sufficient for providing the desired access control rights, or the desired security services. For example, in order to provide child protection there is no need to monitor Outlook credentials. However, covering a large variety of applications allow for more accurate identity resolutions since the identification on one system can be “propagated” to the IMS.

Operations that require user-identification are referred to as identified operations. These operations can be either local applications or remote (Internet) applications. Similarly, we refer to operations that do not require any identification as un-identified applications or un-identified operations. Consider for example Outlook™: when one sends an e-mail Outlook™ may decides which identity of the several ones the Outlook-user is using. Each such Outlook identity is a virtual identity; the real-life person that uses all of these Outlook accounts is a single person. The receiver of two emails from these different email addresses may know, or not know that this is a single person. If the receiver is a user of the IMS system, it is desired that these two email addresses are unified into a single person, logically.

When a local user is interacting with a remote virtual identity this may be a ‘verified identity’ virtual identity (this is typically the case when professional people to interact, and their working place provides the identity verification), or ‘weakly’ identified, as the identity may be just an unknown person from a social network, with a name which may not necessarily be unique. A weakly identified identity is an identity which can be acquired over the internet without any physical evidence. So an email address of a private person is a weakly identified real-life person. The same name with an email account of a company is a more trusted identity.

Identifying the current computer user with high probability enables applying various policies in relation to the user. For example, if child-monitoring (parental control) is desired, and further, web-access policies (known as content-filtering as a part of parental control) are defined, then ideally it is expected that the system should be able to determine at any given moment whether the user is the child. Obviously, if a login-password authentication is in place, then there is an assumption that the operating-system user is also the current user, although this may not be the case. Children and their parents typically share the computer without account changing.

The IMS accuracy in identifying the current-user is measured in two ways:
False identification—the IMS says that the current-user is Mary, and in reality the current user is someone else, say Peter.
No identification—the IMS doesn't provide a decision about the current-user.
Using the suggested methods ‘false identification’ is a temporal state, that typically occurs in transition stages, when users share the computer. During the first couple of minutes the new user is not identified. As soon as the user provides substantial inputs to the system, such as connecting to a social network or other identified application, or as soon as the user begins to type in some inputs, the new identity is recognized and updated. It can be stated therefore, that given a typical 2 hour session, the false identity is in the order of 2%. (2 minutes for 2 hours).
The false identification can be split into acceptable errors (blocking a parent from accessing adult content), and harmful errors (allowing the child to access adult content).
The “no identification” error is typically present only in the training stage, which lasts up to a couple of weeks. After this time, the “no identification” periods become rare, less than 5 minutes a day, and are typically occurring when a new user uses the computer.

The reality though, is that a major portion of the domestic computers as well as other devices that access the Internet today (such as cellular phones and thin-devices) do not require user login; further, these devices may often be shared by multiple users.

In an exemplary embodiment of the invention, it is desired to unify the various identities that appear on such a shared device and group them correctly into the various real-life users, some of which may remain un-identified. This unification process can be useful for associating activities within the various accounts into a single person.

A remote, un-identified person has, naturally different “access-rights”—both to data but also to people.

The suggested identity management system optionally or alternatively provides similar capabilities when handling remote virtual identities. That is, the ability to group remote virtual identities into a single ‘real-life’ or at least a single ‘anchor virtual identity’. This may enable overcoming the multiplicity of names, nicknames and identifiers used within a variety of communication systems.

In parental control systems the parents, or the computer operators, explicitly manage the list of identities, and therefore are required to be aware of all of the virtual identities. Typically, the role of the system administrator/parent in these cases is to provide mapping, typically in the opposite direction. They are requested to provide ‘their child's email, assuming that such an email is unique. Further, other parental control services require the parent to provide further the child's password. Both requests are unrealistic—they assume that the parent knows all of the child's nicknames, emails, etc., and the child is willing to share the passwords to the communication systems with the parent.

For computer operators, it is commonly assumed that a system password is used to control and monitor information and application access. The operator “creates” a new user, and the user can select the desired password.

According to these existing methods, if no user-login access is enforced, in most cases no access policy can be implemented (except for complete access prevention), and hence either every operation needs to be monitored or nothing can be monitored and controlled.

Possibly Related Work

For strict monitoring and access control systems full authentication is commonly implemented. In order to provide authorized and controlled access across some computer network which provides resource access—some standards were defined. [1-LDAP] Lightweight Directory Access Protocol, [2-SmartCard]—using smart card for Identity Management applications, [1-Oracle-IDM], [2-smart-card], etc.

For biometric identification the use of local devices is common, such as fingerprint readers, or iris readers, and for remote identification, some ground-breaking works were published about using speed of typing of passwords. [1-bio] and [2-bio].

Several companies offer remote identification solutions which are based on HTTP protocol capabilities and which recognize the communicating partner by relying on identifying the computer where the communication was initiated. This type of identification falls under the name ‘device reputation’, where the server uniquely (with high probability) identifies the machine that issued the HTTP request, [1-dev_rep] and [2-dev_rep].

Text-based author identification has been a research study in the domain of Natural Language Processing (NLP) for a while [1-Moshe], [2-Moshe]. These works rely on the text's high quality, rich vocabulary and the lack of, or almost lack of spelling mistakes. Not surprisingly, originally, the research focused on Shakespearean works.

Existing author categorization systems, which are dated back to the 60ies, assume a high quality text. Original works in this area referred to Shakespeare's text as the benchmark. More recent works related to scientific texts, to e-mail, and later even to blogs and to Text Messages (SMS) [Author-Moshe], [author-2]. Other works assume that typing speed and combinations of letters can be detected; this is not the case with IM and Chat protocols where an entire message is transferred.

### EMBODIMENTS

Some embodiments of the present invention provide the functionality of a matching (or association) between two user-sets. In the first set, there are some (or all) of the virtual identities encountered locally and/or remotely. On a computer or any other communication device (also referred to as a terminal), all identities are virtual, that is computer-based identities, as these identities are digital name that is, in the best case, is a representation of the actual living personality. The matching provides a translation from a virtual identity (e.g. an email address) into a unique physical-person's name, typically referred to a “real-life person”. It may be the case, though, that there is no “real life person” to be associated with, but instead, only an additional virtual identity. For example, the email address may be associated with one john_dow, where as the address john_dow@hotmail.com is associated with a different john_dow, or even with a real life person. In some cases, though, there is only a computer program “behind” these email identities.

The Identity Management System, IMS, in some embodiments relates to at least two sets of identities. Source and target identity sets. The two user sets are:

(1) Virtual identity set (the source): this set contains a (optionally dynamically) growing set of the nicknames, identifiers (email addresses) and login names that were encountered on the monitored device/terminal These may be local identities and/or remote identities (communication parties of local users). Identities in this set would typically include:

a. Operating system users (local);

b. Email accounts (both local and remote);

c. Social networks identifiers (often relying on emails, but can also be just a virtual user-chosen name or system-selected identifier, both local and remote)

d. Nicknames in various domains (e.g. user-name in a chat room or in a game, both local and remote)

(2) Target identity set (the target): This set may include references to real-life people that were provided by the system users or ‘virtual anchors’ set of users—to whom the virtual users are mapped. Such a virtual anchor is a “John Dow”. There might be multiple, distinct “John Dows” in the system, but each of them represents at least one virtual identity, typically more.

The list of real-life users can be provided by a third party, an external service, or a human. This can be the computer owner, the parent, or the computer administrator/operator, or the Internet Service Provider. The ‘virtual anchors’ are typically created automatically by the system but could be provided by user as well, to allow for combining or unifying multiple virtual identities into such a single ‘anchor’. This may be relevant in the case that a real-life-person is not automatically associated, but still, unique identity is known to exist behind multiple virtual identities. There is no assumption that the real-life user set is complete (that is, that it truly covers the entire user set), or even that it is not an empty set. If however, all of the real-life-users are known in advance, and are continuously sampled, the mapping can be completed faster, as there are identifying samples for each user.

Optionally, the virtual identity set within the source set is not fixed. On the contrary, it incrementally changes as new names appear and some names become obsolete and then can be reused by other people. When a new virtual identity is found, the system begins to learn its “behavior patterns”—it gathers the needed samples about this new identity, and its relationships to other virtual identities on the same computer.

For example, if P@meessenger is now observed, it may be correlated to P@Windows (the user login used in the computer) or to other identities which appear in sufficient frequency and in sufficient proximity during a computer session.

The invention, in some embodiments thereof, describes a method for incrementally learning the association from virtual identities to the target set (that contains both real-life users and ‘virtual anchors’.)

In embodiments where the suggested identity management system is automatic in its nature, it is optionally designed to gather data for its decision and/or fingerprinting engines. In an exemplary embodiment of the invention, this data is based ongoing gathering of session sample data. Based on this session samples identities are detected and defined. In an exemplary embodiment of the invention, samples are possibly not random. Instead, they capture predefined textual, social and additional identification information, to match the fingerprinting engine measured features. For example, if the fingerprinting engine relies on chat line length and typing speed, the sampler may be augmented to provide these elements. The sample may contain also behavioral biometric information, such as mouse moves, typing speed on various applications and the variety of relevant social interactions, such as mail addresses, login names in use, social network activities, chat texts etc. Similarly, samples may contain data from unidentified applications such as word processor. If the fingerprint engine finds this useful for computing and comparing the textual fingerprints—any application in use on the computer can be sampled.

In an exemplary embodiment of the invention, mapping from the source identity set into the target set is provided by a system including some or all of the following modules

a. Source and target identity sets, and an initial, partial matching if available from source to target sets.

b. Sample generator—this generator is used for the fingerprint engine—a tool which, given a chat session log, or an IM session log, or a social network activity snapshot (all of these are jointly referred to as Social Messaging), computes and generates all of the relevant parameters that together provide the unique (probabilistically speaking) identification of that session participants.

c. Fingerprint repository—a fingerprint is designed to match a single target identity in the target identity set (one-to-one mapping). A fingerprint can be computed to based on a complete or a partial sample.

d. Fingerprint matching—a module for rapidly matching the fingerprint of a currently inquired sample to the entire virtual personalities fingerprint repository. The fingerprint matching operation is designed to support the unification/grouping operation, where a new “unknown identity” needs to be tested. Using the matching operation the best matched identity within the target set is selected. Further, this matching is also used to group multiple virtual identities into a single ‘virtual anchor’.

The above modules are listed to reflect a logical functionality, for demonstration purpose only. The fingerprinting relating functions can be grouped, and alternative construction can be designed as well.

In a typical embodiment the system receives inputs from a tracing, or sample generator that feeds the fingerprint engine with requests for authentication or for identification of the current local users and remote virtual identities.

In an exemplary embodiment of the invention, the matching function is not a Boolean function, but rather a multi-value or continuous function, e.g., between 0.1, and really denotes a distance function, e.g., where 0 denotes a perfect match and 1 total difference. The resemblance thresholds are changing over time; as the system matures and more data is available the resemblance threshold can be turned high (as high as 0.95). However, periodically, in order to force grouping of identities it needs to be lowered (as low as 0.6.

Turning the threshold up implies that only very good matches are considered the same person; this is the standard operation mode. Such a high threshold allows for stating that 12@messenger and 1@facebook are the same person with a high probability of certainty. However, in some identified application, insufficient samples may result in poor matching. This may be the case in games, for example, where some form of naming is required, but less textual information is used, and thus samples are either rare or not relevant to the fingerprint. In order to associate such “isolated” identities with already observed identities, the use of lower threshold value can temporarily be used in order to form identity grouping.

### Usage Example I

### Decide Who the Current User is

In this example the system is used to decide who the current user is, out of the possible (typically small number, up to ten users) real-life users. Such a decision may be valuable for various reasons (access control, selective monitoring).

The fingerprint in this case can be based on a typing sample as well as many additional samples (lingual, mouse moves, etc'). In this case, biometric parameters of mouse sensitivity speed of clicking, and usage of various mouse buttons can be used as a partial parameter set; additional parameters can be derived from word processing and word insertion applications—typing speed, vocabulary deviations, spelling mistakes distribution, and language level (as is commonly observed by Microsoft Word™) can be used. In this example, the IMS is an add-on to the access control system that is embedded in common systems, and is used to resolve the current-user at any given moment.

### Usage Example II

### Decide Whether User A on IM and User B and C on a Social Network are the “Same Person”

In this example the system is used to decide whether two or more social messaging buddies (friends) of a local user are actually a single person. A possible way is to compare two fingerprints at a time. Compare A's fingerprint with B's, and then compare with C's and decide if they are close enough. Alternatively, the suggested system associates A with a target identity (virtual anchor or real-life person), and accumulates fingerprinting information for this new entity, which is referred to as an Anchor Virtual Identity. A similar process may take place regarding B. In this case, the process seems redundant however, if later a question arises about a virtual identity C, it can be compared against the joined A-B group, namely, the Anchor Virtual Identity. Even if there is a match, and all three virtual identities are “the same person”, there is no necessarily a “real-life-person” association. In an exemplary embodiment of the invention, the three A-B-C identities are mapped to an anchor virtual identity and the mapping to the real-life-person is optionally provided by a third party.

The IMS can be augmented to issue a policy based alert. This is an optional extension which utilizes the identification capabilities. The fingerprint engine notifies to the Identity Management system about the resemblance of A, B and C, and it is up to the Identity Management system to merge A, B and C into a single identity. Once this unification is achieved an event can be triggered to the appropriate consumer which then responds when such an event is observed.

### Usage Example III

### Avoiding Identity Theft

In this example a message is intentionally sent in a social messaging channel pretending to be somebody else, in order to achieve:
Increase the trust in the message content, based on the owner person's credibility
Cause damage to the person who is supposedly sending the message, based on the content of the message.

In this case the sample is the message itself, and the system is required to decide whether the issuer of the message is has the same fingerprint (similar enough) to that of the person owning the account. The suggested system can optionally be augmented also to decide how to handle the fraudulent cases, once the IMS triggers the response.

### Usage Example IV

### Child Protection on a Content Site

Online predators of children are ideally identified and blocked, or banned from some social messaging sites where children are typically active online. The online predator identity is listed in some “black-list”, which is actually a virtual identity black-list. When a new user requests to join a child-oriented service, the system is required to decide whether this user is one of the members of the black-list. If so, an action can be taken to prevent the new person interaction with children. Common techniques for identifying these people use techniques of “device reputation”, the simplest of which (for the sake of the example) is the computer IP address. This prior art is insufficient for our use, since in many cases device reputation information is missing (e.g. access from an Internet Café). In these cases our new type of fingerprint can be generated for the new member as the user begins to interact within the site/service, and matching can be applied periodically. In a typical scenario, several sentences of an IM session are sufficient in order to completely clear a new user. If the user is not cleared then within a few dozens of sentences the user is identified with high probability as a member of a black-list. Once an identification is completed the desired response or can be triggered by the site operator.

### Usage Example V

### Access Control Enforcement

Common services provided by prior art access control systems typically include:
Access prevention or operation prevention—for preventing unauthorized users from viewing confidential data or manipulating data beyond their authority. This category includes also the “Parental Control” access limitations.
Time limits—limiting the time each user can use the PC.
Content filtering—blocking some undesired content, typically for child-safety
Reporting—notifying the administrator or the parent about user utilization of the various resources and applications.

### Usage Example VI

### Web-Service Personalization

Web service personalization is an effective way to improve site usability and productivity (increase sells and customer satisfaction), but it requires “familiarity” with the web-user. Familiarity may be at a personal level, or based on categorization of the customer base.

When anonymous user surfs a web-site, some information is available (e.g. the browser used, the location, and additional information about the physical device that interacts with the server), however the user remains anonymous. Using the current invention an anonymous user can be either categorized, or even uniquely identified. The latter alternative is typically not desired, as anonymous access has its advantages as well, however, a categorization of the user profile may be of great value to the web site. The identity management service thus can provide grouping of customers based on site to specified parameters.

However, all of these services assume that it is known who the current-user is. By the new suggested ongoing monitoring of the use of a computer the access control systems can become more accurate and can provide access management as desired by policy administrators. Every user is automatically identified, even without a user-password mechanism, and his access rights are granted accordingly.

During the intervals that the user is not identified, conservative assumptions can be used, and thus the user may fail to access resources which he might gain access once the system identifies him

The interfaces for data gathering and to the access control system within a computer are enabled using commonly enabled interfaces and are mentioned in the detailed description of the figures. Briefly saying, the capturing of the data can happen either by capturing low-level of the communication protocol stack, by hooking up with the operating system interrupt handlers, or by providing a kernel hook to the operating system which is responsible for executing a new process, or by combining these alternatives.

### BRIEF DESCRIPTION OF THE DRAWINGS

The present invention is herein described, by way of example only, with reference to the accompanying drawings. FIG. 1 shows the various identities that are monitored and are candidate identities to be resolved, local and remote, real-life-persons and virtual identities. FIGS. 2-6 focus on the local usage of the identity management system and FIGS. 7-8 focus on the remote identities management aspects. FIG. 9 shows some of the parameters that can be used for similarity testing between two different identities (both remote and local). Wherein:

FIG. 1 shows the various types of identities involved in identity management: real-life-persons—who access a local computer, virtual identities—the electronic identities observed on a PC, remote virtual identities, and remote real-life persons. This figure exemplifies the functionality of the system as mapping generator between these various sets.

FIG. 2A shows a high level description of a PC including a monitoring system, in which the local identification system is embedded.

FIG. 2B shows a possible implementation of the input to the IMS with the optional extended format (samples for fingerprinting).

FIG. 3A is a high-level schematic block diagram of one possible embodiment of the system—for automatically associating an account with a real-life user.

FIG. 3B is an example integration of the IMS within the framework of FIG. 3.A for content access filtering.

FIG. 4A shows a possible flow diagram for utilizing an Identity Management System for enforcing access policy even to un-identified applications, either on the PC or even with remote access.

FIG. 4B shows a similar flow diagram for utilizing an Identity Management System for enforcing access policy but utilizing also the optional fingerprint engine to resolve otherwise unresolved access.

FIG. 5 shows a possible flow diagram for deriving identities within a PC where some of the operations are identified and some are not; and some of the identification is not inherently mapped to users.

FIG. 6 shows a possible Graphical User Interface for showing and getting assistance from the computer owner/administrator or even any authorized user regarding the association of virtual personalities to real users.

FIG. 7 is a high-level schematic block diagram of a possible embodiment of a remote-fingerprint engine as a learning system;

FIG. 8 shows a sample chat script; and

FIG. 9 shows a portion of a possible embodiment of the selected parameters of a fingerprint as a vector.

FIG. 10 shows an alternative possible deployment of the suggested system as a global system, residing outside the local PC, and providing global identity management services.

FIG. 11 is a sample possible pseudo code for splitting previously combined group of identities.

FIG. 12 is a sample high level block diagram of using the IMS for site-personalization using direct communication between the site and the IMS.

FIG. 13 is an alternative block diagram of using the IMS for site-personalization using communication only through the browser.

### DETAILED DESCRIPTION OF THE FIGURES

The present invention, in some embodiments thereof, relates to methods and systems for managing identities as observed on a computer, either locally or remote identities. Often there is a difference between the “identity” as the computer observes it, and the real-life-person. Therefore the computer-observed identity is referred to as “virtual identity”. Remote virtual identities are virtual identities that may or may not have local access, but rather, interact with local virtual identities. This typically happens when the local user uses a communication application, such as Instant Messaging, e-mail, or social network. An exemplary basic management service is the association of these various virtual identities with real-life local users (locally), and/or to associate remote virtual identities into a single remote real-life person. The remote mapping is optional, for example, in cases where the above communication applications do not rely on real-life person's authentication. In an exemplary embodiment of the invention, what is provided is the ability to unify or separate remote virtual identities. When multiple remote virtual identities are mapped into a single remote virtual identity, which then becomes the group representative, we refer to as an ‘anchor’. The possible next step of associating the remote virtual anchor to a real person may, optionally take place when the real-life-identity is verified on some point within the system.

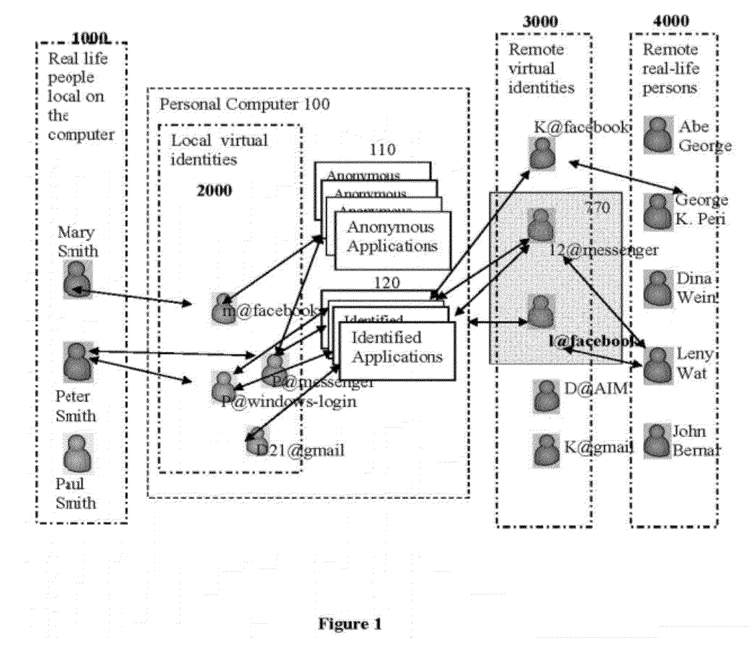

FIG. 1 shows the various sets of users and mappings which may be provided between these sets. In a personal computer environment, there are can be several users.

This is denoted by the real-life people (no. 1000). Each of these users may be using different applications on the local PC (100). Some of these applications require identified access; these are the identified applications (marked as 120). This group typically includes email, chat, social networks applications. Accessing documents may also be managed by user-password mechanism. The users that access the applications, as observed on the PC (100), are referred to as virtual identities (2000). There is often no one-to-one mapping from real-life people (1000) to virtual identities (2000). A real-life person may have multiple virtual identities. Such an identity is the unique identifier used within each domain (sample such domains are Microsoft's hotmail, Google's Gmail, or specific application domains such as Yahoo's chat). For example, each real-life person may have a window-login name, as well as several other specific domain names.

Other applications may not require identification. This is typically the case for most Internet pages and local applications on the PC. These applications are referred to as unidentified applications (110) or anonymous applications. Still, even these applications may provide indications or may have different policies had they known who the user is. Using the IMS these unidentified internet services can use personalization, content access control, and/or other capabilities. These applications are all potential consumers of the identity management service described in this system. These applications may accept triggers that the identity management system produces, and set the appropriate response based on their specifications.

Personalization of web pages is a well studied and highly advanced technology. The purpose of web page personalization is to become more effective and customer focused in providing the relevant content to the customer. Web sites go through a substantial effort to generate cookies, to monitor usage paths within the site, and to track user clicks in order to better tune the content, the advertisements and sometimes even the pricing to the customer profile.

Using the IMS, the same page could be personalized based on identification information provided by the IMS to the web-server. In this case, the web-server can provide different contents and advertisements to father, the mother and the children when they access the same page.

Within both groups of applications (identified 120 and unidentified 110) there may be communication supporting applications. An example of unidentified communication application may be a game or even a chat room, where names are provided by the remote server, or application provider. In communication applications the local virtual identity encounters remote virtual identities (3000). The optional management of these identities is a potential additional use of the current invention. Each such identity is (typically) a unique name within the domain or application where the communication occurs (Messenger, AIM, Yahoo, Gmail, Hotmail, Facebook, and similar services.) It is important to note that most computer-users today hold more than a single virtual identity, that is, most people have more than a single email, social network name, chat name and the like. One possible way to overcome this would have been if any remote virtual identity would be mapped to a remote real-life person (4000), which is a unique entity. However, this is impossible in most cases, as each social network has its own identification assumptions. Therefore, the association, denoted in arrows, between remote virtual identities (3000) and remote real-life persons (4000) is often incomplete or missing altogether. This detachment is the foundation of the anonymity strength that the internet provides, but also the source of mistakes and dangers it exposes. Optionally, the system provides an alternative grouping or separating of remote virtual identities instead. The group (770) of remote virtual identities denotes, for example, that 12@messenger and 1@facebook are really the same person. The system may not necessarily “know” who this person is, and an “Anchor virtual identity” is created—by the group formation 770. It is important to notice that this grouping capability may denote that with high probability the other virtual identities do not belong to the same anchor, hence, they represent a different real-life person.

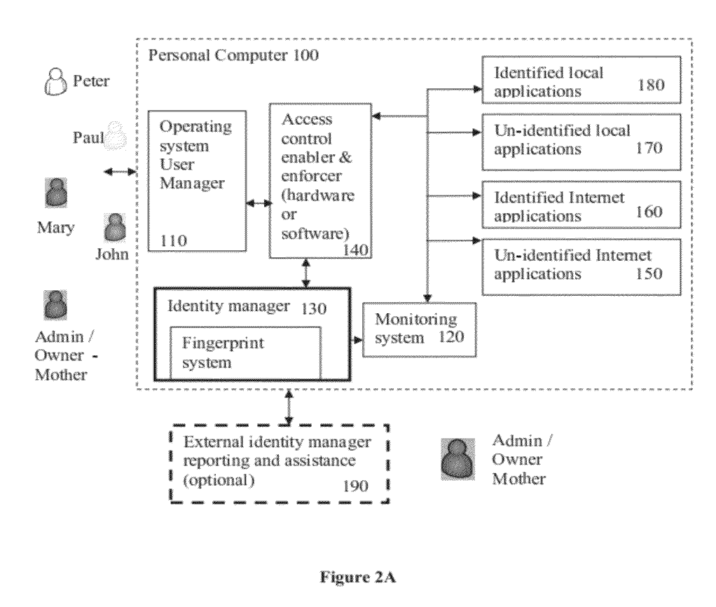

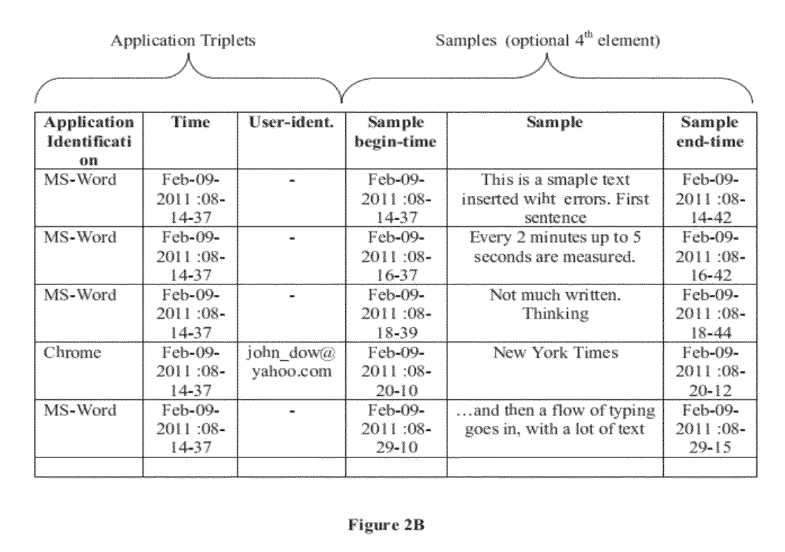

Splitting of an anchor may be required for two reasons, both represent that an “over-grouping” has occurred:
Two distinct real-life people share a single virtual identity (domain-name, or email). This commonly happens between generations (a parent that uses the child's email and vice versus) or among couples.
   Two distinct virtual-identities that actually represent two distinct real-life people but have been erroneously grouped into a single virtual-anchor, due to some resemblance in a dominant set of parameters must be separated. Such a mistake can typically occur for members of a small very unique and distinct minority. For example, two immigrants from the same foreign state, who live in the US. Typically both of these people will have similar spelling, grammatical and sentence-structure errors in English. Even if these two persons live far apart, and use distinct virtual identities (each has his/her own email address), the system may erroneously group them into a single virtual anchor. As long as there is insufficient evidence, these two distinct people and distinct virtual identities will remain grouped. Reference is now made to FIG. 2.A, in which a possible embodiment of the identity management system is shown. In this example, the management system (130) is a local one (resides on the PC, 100). On said PC an operating system is installed (110), which may provides also Access Control Enabler (140) in the form of User-Password authentication system, or using some external hardware device. (There is no assumption that the Operating System enforces user-password access control. On the contrary, in most cases, most of the accesses are not tightly connected to a named-user on the operating system. In the cases user-login is enforced, the default assumption is that the initial current user is the logged-in person.)

Additionally, some monitoring system (No. 120) is installed. Such a monitoring system traces any action any of the users performs. The users (on the left, marked Peter, Paul, Marry, John and Admin) denote real-life people, can either login to the system using the operating-system access control (140), but can also interact with the variety of applications installed on the PC when such a control is not enforced. These applications, or the operations performed within these applications are grouped into four groups (150, 160, 170 and 180). The applications groups include local and remote (e.g. Internet-based) applications, and can be either identified or un-identified applications.

While at the operating system level it is common to map real-life users to operating system accounts, and typically, it is the administrator/owner of the computer that performs this mapping, at the application level, be it local or remote, it is the user that sets its access name, and the user often uses a variety of names. A typical example is mail names: above mentioned user Paul may want to call himself Paul@yahoo.com, but it may be the case that Paul@yahoo.com is already in use, and the user then reverts to psmith@yahoo.com, while his brother, Peter, uses P_smith@yahoo.com. Accordingly, when either Peter or Paul accesses their Internet e-mail account, for an outside observer, there is no way to distinguish between them. Obviously, the mailing system distinguishes between the two. However, without additional supporting information this separation seems impossible. One possible way is to rely on said operating system access control (140) system. However, Peter and Paul may simply keep the PC running, ignoring completely the operating system access control system. This is the case in most homes, and in a large portion of in-work PCs.

Applications 150, 160, 170 and 180 may be easily identified, as is the case when accessing the work-based mailing system, using application access control, such as in Outlook™. Other shared applications do not require authentication: word processing, games, number processing, etc. These applications would naturally belong to the “Local, Unidentified Application” group, No. 170. The suggested system (for the local identity management) resolves the challenge of locally differentiating between Paul and Peter, and suggests identification for the current user based on user's behavior.

Similarly opening a browser and surfing the Internet typically does not require user-authentication (Application group 150). Accessing email, shopping, financial applications, health related applications, games and social-networks applications are personal applications, and typically do require authentication relying on user-login mechanism. These would naturally belong to the “Identified Internet Applications”, number 160. Using the IMS without any explicit user authentication process (e.g. physical fingerprint, user-login, etc) a high level user authentication quality can still be provided.

Upon accessing any of the applications (150, 160, 170, 180) the monitoring system 120 traces, or grabs the activity and gets a variety of data elements.

The gathering interfaces and methodologies for gaining this information are mentioned below.

For the sake of this invention it will be assumed that the monitoring system gets three parameters for each identified application access (or two for unidentified applications):

1. Application identification, which is the application name for local applications, or URL (Unique Resource Locator) for Internet-based applications.

2. Current time—the time the access occurred.

3. User-authentication (name, at least) for identified applications of groups 160 and 180. (Monitoring systems typically refrain from getting the password in addition to user name, and it is not required anyhow).

For simplicity these three elements will be called Access-Triplet (AT).

The second element (the time) may be omitted at the monitoring level, and added by the IMS, but for the logical processing of the data, it is assumed that each application access it timed.
For supporting the additional (optional) fingerprint engine, additional data may be desired. This data is gathered using similar techniques by the monitoring system (120). In the case that fingerprint engine is enabled, the information is actually a quartet, where the forth element is the sample. The sample of a textual-receiving application includes typically the text and its insertion times. This is designed to enable typing speed related parameters. The fourth element thus, may include timing and sample texts that were timed. Examples of a possible AT sequence, with the optional samples are shown in FIG. 2.B.

Said monitoring/capturing component (120) can be implemented either as a hardware device, or as a software application within said PC (100), or can even be a part of the operating system.

The implementation of the monitoring/capturing component is a known technology. For example, in the Windows operating system family, it is common to provide hooks, or plug-ins that allow for interacting with any of the computer applications. Such hooks allow for redirecting the lower level interrupt system of the operating system. If this solution is selected, any interaction on the computer, any key-stroke and mouse move is replicated, and transmitted also to the monitoring/capturing component (120). See for example Microsoft's Developer's documentation [MS-5]. An alternative implementation for browser based internet access applications (such as Internet Explorer, FireFox, Chrome, and the like), as well as for communication system is to capture the communication at the protocol stack, typically just past the communication driver. For example, the capturing of any HTTP request/response can be done using capturing of any TCP packet that is transmitted (in & out). See for example several companies that provide software for such capturing. [TCP-1], [TCP-2].

Another example for Windows families is to use existing hooks of the Kernel when it activates an application requested by the user. The hook will direct the call to the Access Control module, that will decide, in real-time, whether to allow the activation of the requested application or not.

Yet another implementation method is one of the key-logger applications which are commonly available. See a survey article about this in Wikipedia [WIKI-1].

On a Linux environment alternative kernel mode processes allow for overriding and capturing program interfaces, and altering on the fly the permissions granted for accessing a file or a process. Most of the tools that exist on Windows have their equivalent on Linux as well. (See [WIKI-1]).

The interface to the access control systems is typically achieved in a similar manner. That is, typically by hooking into a kernel mode, and blocking access rights to applications before they begin their operation.

In the cases where operating system (OS) access is strongly enforced the monitoring system can rely on the OS access control to uniquely identify the user. When this is not the case, the monitoring system can submit, using some embodiments of the current invention, the AT to the identification management system, (130) (marked in dark line). The role of the identity management system is to decide ‘who is the current-user?’ That is, it is the role of the identification management system (130) to decide which of the known people that the administrator or computer owner cares about is actually performing the access to the application. The decision can be reported to the computer administrator by interacting with a remote (optional) “external identity manager reporting and assistance” interface (190), which can be Internet-based, or cellular-based, for example. Said external system 190 provides information to the administrator/owner of the computer, but can also get insights from the administrator/owner, in the form of helping the identification system (130) in deciding ‘who is who’. In the above example, the parent of Peter, Paul and Mary, may provide the information that psmith@yahoo.com is Paul, and p-smith@yahoo.com is actually Peter.

The additional information that are the input for the Fingerprint Engine 2405 are described in the following FIG. 2.B as an augmentation of the AT.

Given this information the Identification Management system 130 can provide better information to the “Operation Access Policy Manager” (No. 140). For example, as Peter may be 21 years old, he may want to gain access to any content on the Internet, while Paul, being 14, may still be restrained from accessing adult-only classified content.

Said policy management system (140) then interacts with the various applications to limit/block/report or permit the access, as desired.

The role of the suggested identification management system (130) to decide who is the user that performs any operation, for both identified operations (such as those using email), but also for unidentified operations, such as those using the browser to access an open, free newspaper, or a word processor, for opening a document. In some cases the system may realize after the fact who was the user that performed a certain operation. Based on the decision about the current-user, the system can trigger an event to the access-control enabler and enforcer 140. In an alternative optional implementation the additional enforcing of the policy are included in the IMS itself.

For the sake of simplicity, the identity management system (130) is described as local to the machine. Alternatively, this can be implemented as an external system, or a hybrid. In both configurations, it may have an interface to an external system or display to external users. This is denoted in the external interface (190).

Reference is now made to FIG. 2.B which shows a possible implementation of the Application Triplet mechanism, with some Application Triplet examples. In these examples the ATs are augmented with the sample data that is later used by the fingerprinting engine. The first row in the table shows an AT which indicates that MS-WORD application was opened, at what time. Since in this case the usage of this application is not access-controlled, the user-identification is missing. The first few rows also include sample texts that were typed by the user, and their timing. Using the begin and end-times the typing speed can be calculated. It is assumed that only a portion of the text is sampled. In this example every 2 minutes, 5 seconds of typing are sampled.

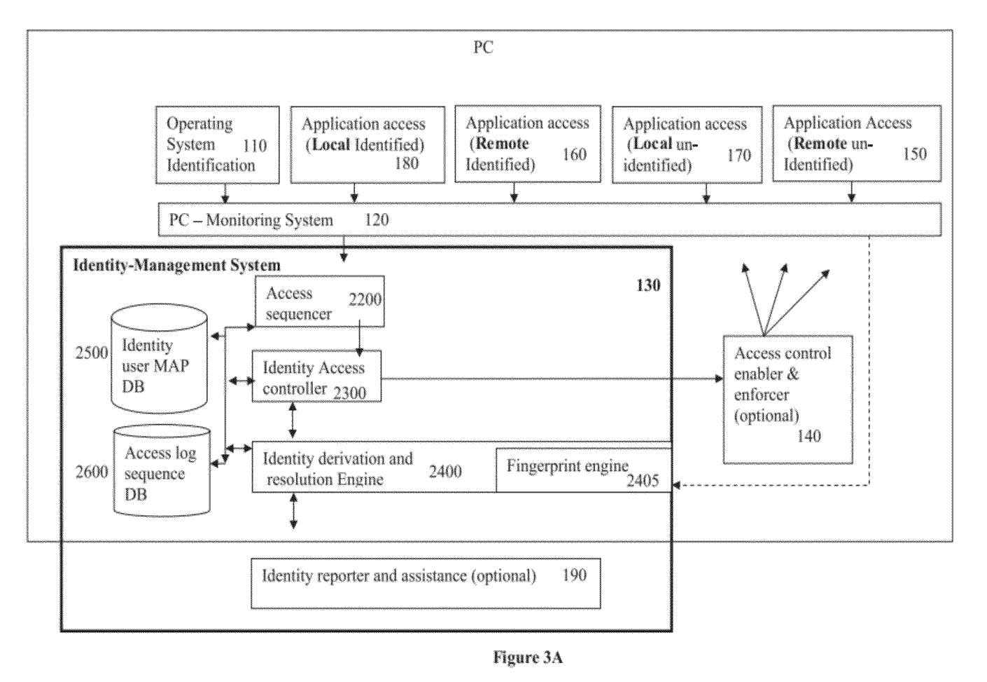

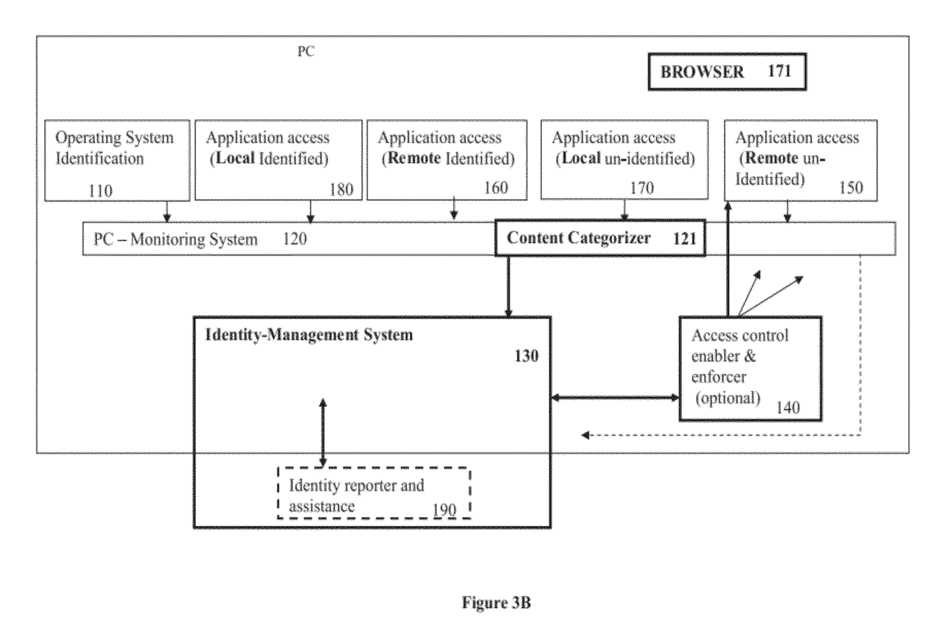

Reference is now made to FIG. 3.A, where an optional possible embodiment is described by showing the components of the Identification Management System.

FIG. 3.A shows a PC with same applications as in FIG. 2.A, with OS and various applications (150, 160, 170 and 180) as before, and a monitoring system 120, that traps any application access triplet as before (AT), (and optionally also the samples for the fingerprint engine, as before) and transmits it to the identity-management system 130 as before (marked in dark line). FIG. 3.A shows the internal components and the interactions between these components. As can be seen the Identity Management (IMG) System (130) has at least two interfaces to the applications on the PC: an input in the form of ATs (and optional samples, marked as dashed arrow) from the Monitoring System (120) and outputs to either the “Access policy enforcer” 140, or to the optional, external “identity reporter and assistance” 190. The interfaces shown in FIG. 3.A enable monitoring, controlling and blocking access based on content-type, application-type and other categories of both identified and un-identified operation, to both local and remote applications, as well as to operating system's services. Alternative embodiments can restrict the access to specific applications or to specific contents or to specific operating system services.

Upon receiving an AT from the monitoring system 120, the IMG system sends it to a sequencer component 2200. This may be helpful as the monitoring system 120 is not obliged to delivering the ATs in a timely sequence, (but at a nearly, pseudo timely sequence).

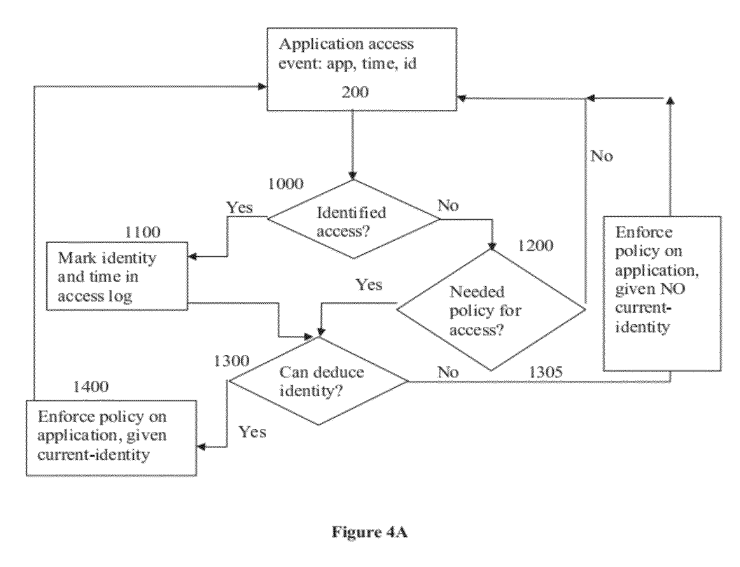

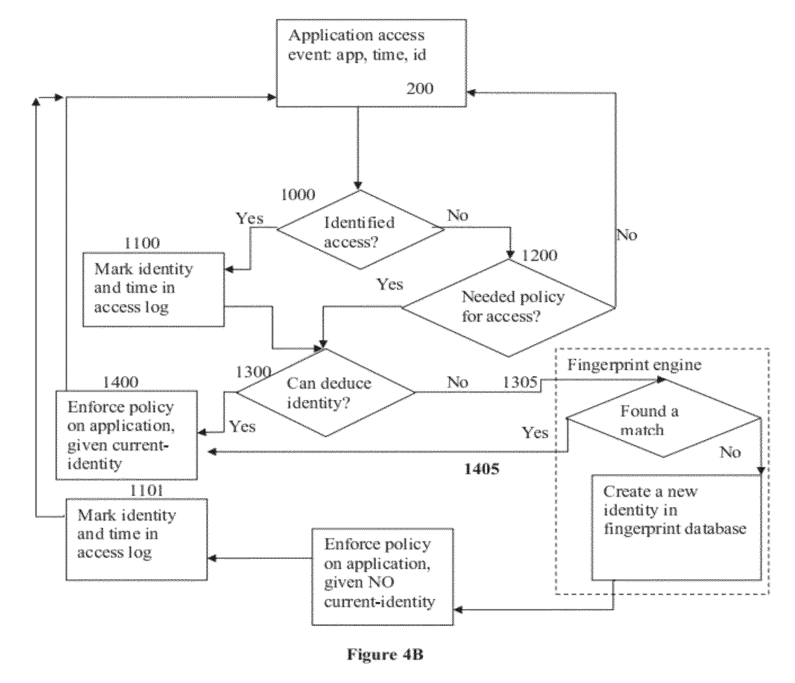

The Sequencer 2200 transfers an AT at a time, or a sorted sequence, in its timely sequence to the “identity access controller” 2300, but also stores the AT in the access log. The “identity access controller” 2300 runs a quick logic (listed in FIG. 4.A), typically in real-time, to decide whether there is a need to interact with the external “access policy enforcer” 140, or whether a refined identity is preferred and then it may decide to activate the “Identity derivation and resolution engine” 2400.

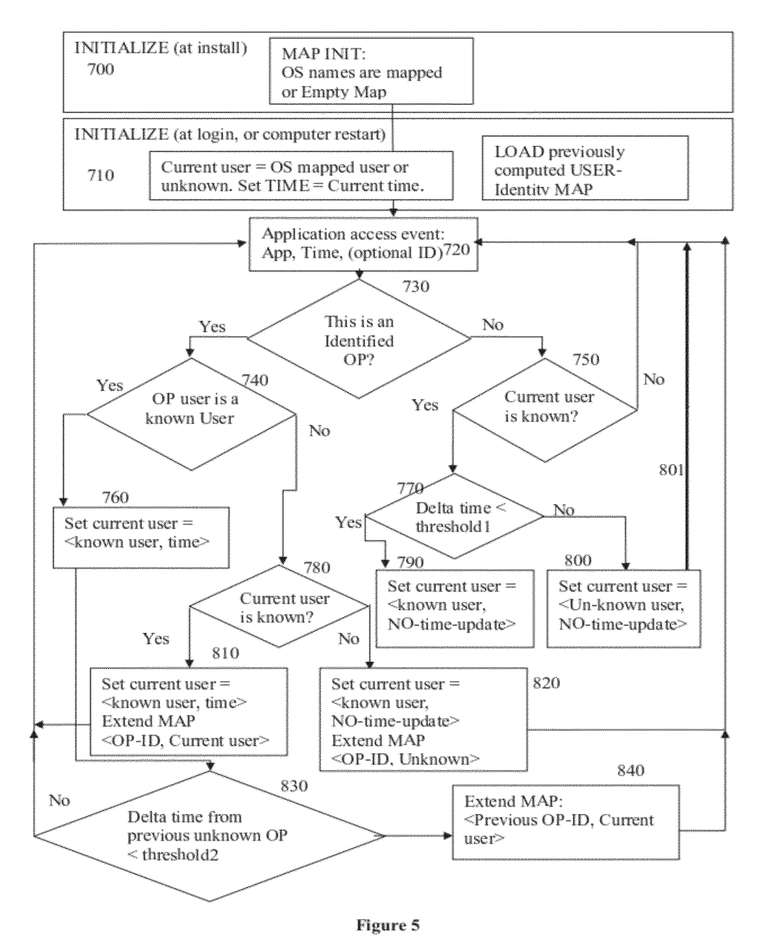

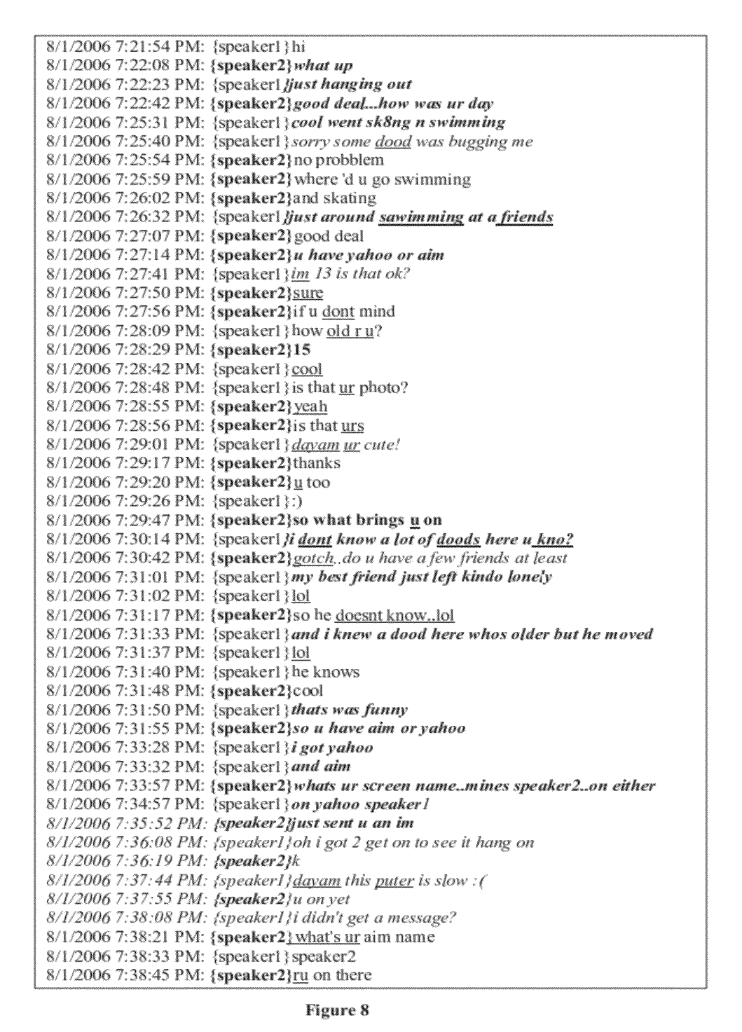

The derivation engine can optionally use a statistical, heuristic method as described in FIG. 5, below. However, it may also make a reference to the fingerprint engine which is optionally included in the system, (2405). The fingerprint engine, though takes as an input a sample (the fingerprint data), or, sometimes, the sequence of ATs can form a fingerprint, in order to perform the identity resolution process. This sample data is provided by the monitoring system 120 as well, directly to the fingerprint engine. The description of the fingerprinting engine and the sample data it uses are described in FIGS. 8-11.

The sequence of ATs which includes information regarding access and operations is stored in a DB, the “Access Log Sequence DB”, 2600. Unlike the “Identity User Map” 2500, this database is in optionally use only within a user session, and further, it is typically used only for a short time interval, for example, to allow for resolving current events based on the near past events, or vice versa, to resolve past events based on current events. This is explained in more details while describing the logics of the “Identity derivation and resolution engine” 2400.

By storing this information only until the last identity is resolved the privacy issues are eliminated, as the system stores no specific content generated by the user for more than a few minutes. This allows for maintaining privacy even when the system is implemented as a remote, global system.

The flow diagrams that represents a possible logics of these two components, the “identity access controller” 2300 and the “identity derivation and resolution engine” 2400 are shown in FIGS. 4 (A and B) and FIG. 5 respectively. FIG. 4.A shows the identity access controller 2300 without the fingerprinting, and FIG. 4.B shows the insertion of the fingerprint engine into the same controller logic with the fingerprinting engine.

The components shown in FIG. 3.A are shown to denote that a decision about the identity can be made based on a sequence of operations (even if just some of them are identified applications). Further the system can provide an identity decision about the current user even when all the operations so far were unidentified. This can be achieved given some previous knowledge about the user behavioral patterns, which is the role of the fingerprint engine. This fingerprinting technique is described in the sequel. The fingerprint returns the most likely current-user given the current AT, (or several ATs.)

In an exemplary embodiment of the invention, this decision about unidentified operations is the role of the “identity derivation and resolution engine”, 2400 of FIG. 3.A. The role of the “identity derivation and resolution engine” 2400 is two-folds:
a. To associate un-resolved identities, that occur within a sequence of identified operations, with already resolved identities, and by doing so to enrich the mapping between virtual identities and real-life users. This mapping is stored in a permanent storage “Identity user MAP DB” 2500. And
b. To associate un-identified operations that occur on the PC with the person that is assumed to be using the PC at the moment the operation takes place, so that the desired access policy can be enforced.

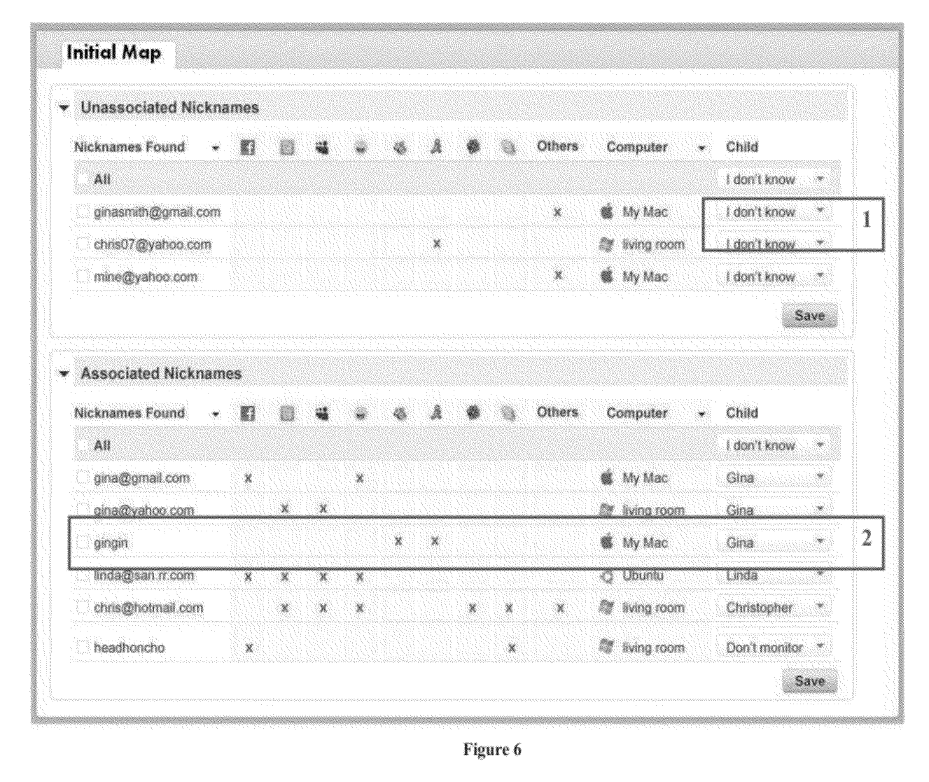

The first role can have a meaningful value for the administrator/owner of the computer, as well as for the guardian parent, and accordingly provides valuable information to the monitoring system. Further, while reporting about observed identities, the administrator/owner or parent can provide more assistance, and by doing so completing missing pieces within the identity-user mapping. A sample Graphical User Interface that allows for reporting and for getting the administrator's assistance is demonstrated in FIG. 6. The administrator assistance can provide approval, refinement and/or augmentation of the mapping.

Using the optional possible implementation of the GUI shown in FIG. 6 an authorized user (parent/administrator or other such user) can view the observed virtual identities (marked as “Nicknames Found” on the left column of the GUI), observe in which domain (social network, or IM engine) the name was observed, and finally—map this user as shown in Rectangle 1 in this figure. The user is (optionally) requested to provide only this input—the mapping to real-life people. Using a drop-down menu, for example, the user can select the real-life user that he wants to associate with this virtual identity, or alternatively state that he is not aware of the real-life user—and leave it as “I don't know”. The system can also automatically suggest some such associations—as shown in Rectangle 2. In this example the nickname gingin that is used in Messenger and in Yahoo on the home computer referred to as “My Mac” is associated with Gina. Another alternative which the user can choose is “Do not monitor”. This is shown in the bottom most row. In which case this user will not be monitored, and any IMS decisions will not be applicable for this user on the local machine(s).

As stated before, while the “Do not monitor” option is applied locally, it may be the case that for other users on remote machines, this identity will be monitored and tracked. For example, this may happen when the user headhoncho in Facebook, as shown in this GUI example is either accessing other social networks, or interacting with people that request remote virtual identity management services. In such a case no local information will be provided to the IMS but remote participants may provide the needed information.

The use of a user input as shown in FIG. 6 is optional. However, such an input allows for a faster bootstrapping of the identity management service, actually turning it into a fully automatic service, which does not rely on external inputs. It is our experience that for home computers within a few days of normal usage most of the identities are observed, and thus within one path on the observed identities the user can provide the necessary information for the seed data. From there on the automatic deduction can be applied.

Reference is now made again to FIG. 3.A. The second role of the “identity derivation and resolution engine” 2400 is to enable enforcing usage policies and personalization by being user-sensitive in places where today's systems are not aware of the user. In these cases, monitoring systems which do not have user-resolution without identification will be either too restrictive or too liberal and will not be able to distinguish between the various users.

An example usage of this identity derivation for access control is given in FIG. 3.B. In this example a filtering of undesired Internet content is shown. The user (not shown) browses Internet pages using an Internet Browser 71, marked in bold rectangle. (For simplicity it is marked as “remote un-identified application). Content filtering policies may be applied by parents or computer owners. In this case the IMS utilizes an external (or optionally integrated) content categorizer component (121). Typically this is a part of the PC-Monitoring System 120, and is implemented using similar techniques as mentioned before for capturing any external page access (at DNS level), and then issuing a similar DNS request for category interception. This information is then transferred along with the AT information to the IMS (130), which then decides who the current-user is, and interacts with the Access control (140). If policy enforcing is required for the current-user, for the given content category—the Browser is then forced by the Access controller to respond properly, for example: continue and load the page; block the page; warn about possible inappropriate content and allow viewing the content if desired, and other such behaviors.

A possible embodiment of the second capability of the “identity derivation and resolution engine” 2400 is by storing behavioral information of the user, so that behavioral fingerprinting can be generated. This is explained in more detail with reference to the remote virtual identity unification.

An optional additional role of the Identity Derivation and Resolution Engine 2400, in the cases where fingerprint engine is present, is to accumulate the sample data and push it to the fingerprint engine with the matching identity.

Reference is now made to FIG. 4.A, which shows a possible embodiment of the real-time “Identity Access Controller”, 2300, of FIG. 3.A.

The logics of this component in one example can be described in the follow pseudo program:

200: For each Application Access Event (AT):
Begin

| | |
|---|---|
| 1000: | If this is an Identified Access (The ID part of the AT is not |
| | null)? |
| | Begin |
| 1100: | Log the activity in the access log sequence DB (2600) |
| 1300: | Can the identity be deduced? If yes (deduced identity) |
| 1400: | Enforce policy (application, time, identity) |
| | Otherwise (don't know who it is) |
| | Enforce policy on unknown current_user; |
| | Break; /* Wait for next event; Transition 1305 */ |
| | End else /* this is NOT an identified access */ |
| 1200: | Is there a need to apply access control policy? |
| 1300: | Can the identity be deduced? If yes (deduced identity) |
| | Enforce policy (application, time, identity) |
| | Otherwise (don't know who it is) |
| | Break; /* Wait for next event */ |
| | Break; /* Wait for next event */ |

End /* of for loop */

The purpose of the Identity Access Controller is to rapidly decide whether access-control is required at all for the operation that is presented in the AT, and if so, whether a “Current_user” can be deduced. Once the current-user is either resolved or left unknown, the relevant policy is applied.

As shown in FIG. 4.A, there is a possible case where there is a need for control policy but no identity is recognized. This is marked as transition 1305 in FIG. 4.1. A potential advantage of some embodiments of the current invention is in its ability to deduce an identity even for unidentified operations and/or even in a sequence that contains no identified operations. Such a decision can be reached using sequencing observation, as described in FIG. 5. However, in the cases where the deduction system cannot resolve the current-user, fingerprint engine can, optionally, be deployed. This is shown in FIG. 4.B.

In another possible, optional, embodiment, as shown in the dotted rectangle in FIG. 4.B, the fingerprint engine resolves these cases that were not resolved so far, using similarity and matching of various patterns (as described later, in reference to the fingerprint engine). The transition 1405 (marked in bold) really indicates the cases that couldn't be resolved without the fingerprint in FIG. 4.A, and can be resolved using the fingerprint engine. This may yield a much more accurate policy on the long run, when the fingerprint engine accumulates sufficient data.

Reference is now made to FIG. 5, in which the Identity Derivation and Resolution Engine is explained in more details, as a possible workflow. The purpose of this workflow:
1. To decide “who the current_user is”—so that access policy can be enforced. Setting the current_user means that the system is aware of the person who is currently using it.
2. To extend the user-identity map, by learning:
   a. New identities that are candidates for resolution. Mapping such unresolved identities to users, based on usage patterns.
   b. Setting sufficient information for the fingerprint engine to extend its map

The workflow in FIG. 5 shows a possible pattern for deduction, based on two time thresholds. These are brought as an example to show a possible implementation, and are not meant to be the binding or restrictive description of the invention.

The timers threshold1 and threshold2 are set to allow for multiple users to use the same computer. The logic that is embedded in these thresholds is that users interact with the computer for at least a few minute “session”. The thresholds are set in such a way that as soon as the last “testimony” for identification becomes too old, the current-user becomes invalid.

A much more coarse grain alternative can be thought off, where only identified operations are used; another alternative is to rely only on the Operating System ID.

In decision point 770, the system tests whether the operation-time as provided within the AT (Access Triplet) is close enough (time-wise) to another identified operation. If this is the case, it can be assumed that the current user is the previously identified, known user.

Similarly in the decision point 830, based on an identified operation, when the current_user is known, the system extends the map to include a new virtual-identity, which is mapped to the same user. Hence, in terms of the previous examples (of FIG. 1) the system learns the P@messenger is the same person as P@windows-login. Such learning is feasible simply by sequencing of identified and unidentified operations.

Typically, when just installed, and when the map is relatively empty, the system starts in accumulations mode of new virtual-identities, and the current-user may not be known at every given moment. However, given the correct seed of information, such as can be provided by the system admin or parent, the system rapidly accumulates the relevant mappings from virtual identities to real-life users. It has been observed that the most used identities are detected within hours of normal use, and a steady-state map is achieved within days of activation.

When the system is at this initial stage it is not aware of the “current-user”, and thus enforcing detailed access policy is limited. At this stage the system acquires virtual identities and sample data correlated to these virtual identities. However, already at this stage the IMS provides substantial value to the administrator/guardian parent, as it allows the parent to know the various identities used by the computer users/their children. This is demonstrated in FIG. 6, where the user gets a report regarding observed identities.

As can be observed from the flow diagram of FIG. 5, there are several cases where although there is a desire to monitor, or to resolve, who is the actual person that uses the computer, there may be insufficient information to do so, using only identified-operation hints. This is marked in the bold transition from state 800, marked 801.

In order to overcome this, the invention is optionally augmented with the fingerprinting identification capabilities. Such an augmentation can be done by combining “typing, biometric” technology, which then allows for uniquely identifying each of the users, and even to assert about an identity that it is not one of the known identities.

A biometric typing technology measures speed of typing, mouse moves, etc, in order to uniquely map operations into users. Such a technology can be used to improve identification of otherwise anonymous operations, such as using a text-processing or spreadsheet application. An additional fingerprinting capability is the lingual one. Both are described in the bellow, when reference is made to grouping of remote virtual identities.

Reference is now made to FIG. 6, where a possible GUI is shown, in which the administrator/owner or parent can observe and modify the mapping from known virtual-identities to users. Using a similar GUI the user can provide some assistance as to what he/she considers to be the correct mapping in those places where the system failed to do so. This human interaction is optional, and is designed in order to expedite the identity learning process. In particular, it may be assumed that the administrator provides a list of possible people who use the PC. This list is show in the drop down list that is activated when the user clicks the “down arrow” in the “Child” column in FIG. 6. By selecting a member of this list, the user indicates that this is the correct mapping. However, even providing this user-list is optional.

By using the sample data about each identity and user an improved identification can be achieved. Similarly, by using behavioral information, such as typing speed and unique lingual characteristics a new type of fingerprint can be formed. The fingerprint engine is applicable for both local and remote users. The difference would typically be in the system configuration.

For remote users such a system would typically consist of a central (global) system, which manages a global storage of remote virtual identities. However, this may also take place for local identities on the PC itself, where the number of identities is typically several order of magnitudes smaller. While on a PC the typical number of users is less than 10, in a global system that handles also remote users, millions of users can be managed.

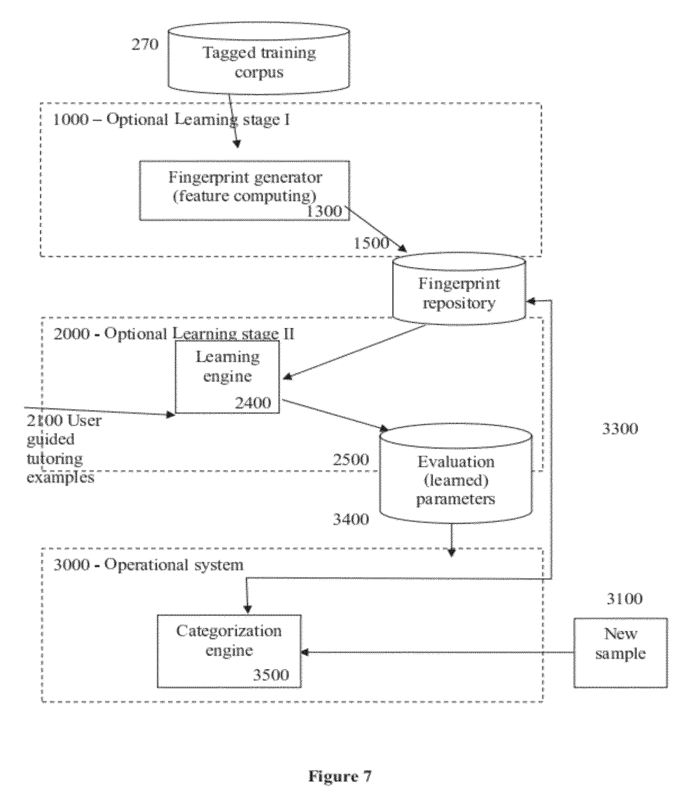

Reference is now made to FIG. 7, which describes a global fingerprint engine as a learning system. The corpus (270) is used for analyzing a variety of possible parameters such as the distribution of words within the corpus, the multiple possible spelling of each word—common errors for each word, the normal response speed and typing speed per character and for specific character sets; the normal response time per sentence; the normal ‘multi-sentence’ distribution, and the normal distribution of emoticons (e.g., smiley's).

Given the normal values for each of these parameters, each of the authors' texts is then analyzed, and a vector (a fingerprint) is computed for each virtual identity.

Based on the computed fingerprints, training or learning takes place (2400), in which tagged (authenticated texts) are submitted to the learning engine, which then learns based on the feedback from the user-guided tutoring examples 2100, the correct weights for each element within the fingerprint vector.

Once this process is completed, the system has gained two databases: a reference fingerprint database 1500, and a weight database 2500, referred to as Evaluation (learned) parameters. At this stage the system is ready for use and is in an operational mode. From this stage on it can be used in unsupervised mode: new samples (3100) can be submitted with two types of categorization queries to the Categorization engine 3500:

1. Who is the most likely author(s) of the text? and

2. What is the likelihood that the chosen author is the correct one?

If insufficient likelihood value is retrieved, the new sample can be defined as written by a new identity, and fingerprint for this new author is then computed. A new sample is the information that is gathered by the Monitoring System (120) of FIGS. 2.A and 3.

Using the terms of FIG. 1, local virtual identities (2000) of unidentified operations are mapped to a real-life persons (1000) using the fingerprints. Similarly, remote virtual identities (3000) are mapped into a virtual anchor such as 770) or remote real-life persons (4000).

The feedbacks of the operational system (no author found) as well as classification decisions are fed into the fingerprint database and into the corpus repository. These are optionally used in an iterative mode for a successive learning cycle.

FIG. 8 provides a fragment of an IM interaction between two speakers. The text is brought in order to exemplify the quality (or lack of quality) of the text, and the observation that common spell checking techniques cannot be applied.

The figure shows the results of feeding this sample into a speller, such as Microsoft™ Word spell-checker. Obviously this attempt yields poor results, as relatively high percentage of the words are marked as spelling errors, and most of the sentences have poor grammatical structure. The heavy use of non-standard language actually turns it into a personal language—the lack of fixed word spelling and lack of standard sentence structure is a highly useful and meaningful characteristic that is used to identify the author. In this figure bold marked sentences denote sentences that do not have even a close to a normal structure; underlined words denote words which are not recognized by Microsoft Word's spell-checker.

For example, the sentence:

“cool went sk8ng n swimming”

is marked as hard to parse. The following entire sentence is not marked:

“sorry some dood was bugging me”

Instead, only the word “dood” is marked as a spelling mistake. The use of punctuation marks in this domain is saved for combining emoticons, and therefore the absence of a comma or a period sign do not cause the entire sentence to be marked. When a punctuation mark does appear in its original sense, it is rare, and accordingly can become a feature in the fingerprint vector.

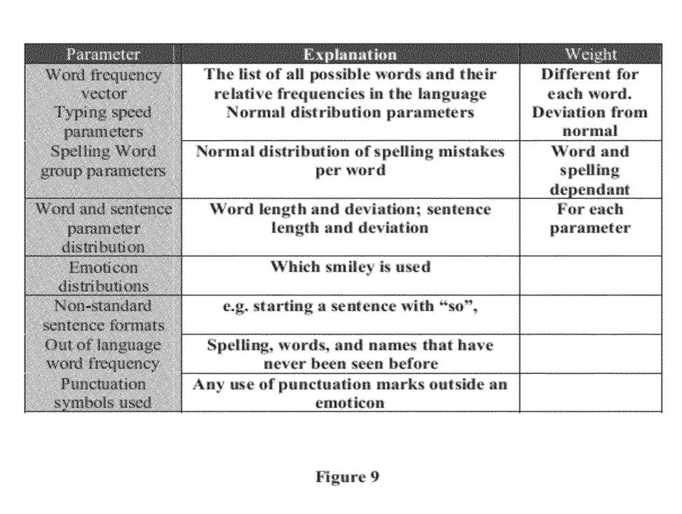

FIG. 9 shows a simplistic representation of some of the elements which optionally can be included in a fingerprint vector. This vector may include for each parameter the measured value for this author or for the tested text. The figure lists some of the observed parameters. The first parameter—word frequency, is the standard vector used for categorization. Typing speed related parameters are not available in standard text, and therefore were not used before. Spelling mistakes were used before, however, they were used as a rare value, thus pointing to the frequency of mistakes, and possibly also to their types (e.g. letter swapping). In the current context, incorrect spelling is the standard, and therefore these are used as standard words.

Standard word vectors use stemmers and spellers to group possible words into the “original form”. Given these techniques the word vector contains several millions of words. Using “incorrect words” does not alter the size of the word vector. However, since words cannot be grouped relying on simple “spelling-distance”, alternative grouping techniques are used. This requires maintaining a live “chat-lingo” dictionary, such as available on the network, and augmenting it with commonly observed unique spelling of words.

The following aspects of chat content and IM can be considered, and were not available for standard document author categorization:
Non-standard language: users tend to create their own, personal abbreviations, typically phonetic ones. For example—the word “probably” can be written as “prbbly”, “prbbli” and many other ways. “See you later”—can be written as “C U Later”, “cu later”, “C u l8tr”, and many other variations. The choice of the writing form is specific and typical to the writer, in a given mood, at least.
Non-standard use of ‘emoticons’—within the text. This includes the various ‘smiley's’, and once again, these have unique personal touch.
Spelling mistakes, especially those based on rapid-typing and on common disabilities, such as dyslexia. Unlike other texts, trying to run a common spell checker on Chat and IM traces yields over 50% errors. Further, most of the sentences are incomplete or incorrect grammatically, even if some ‘normalization’ takes place.
Timing aspects—while typing speed of passwords have been observed as a possible authentication method, the ability to time unknown, free text, and conversation speed is a much more challenging and useful method. As chat and IM logs are padded with timing information, the time it took each author to complete the typing process can be inferred. Further, not only typing is involved—the nature of people interaction in this context is similar to the conversation mode—where the response speed can be used to identify each person.
Content dependent—a majority of the chat and the social network interaction is personal communication in which the partners describe themselves either explicitly or implicitly. While people often generate new names and identities, it is rare that a person also alters a meaningful portion of their personal description. People often alter their age, make it either older or younger, according to need. But the combination of the variety of parameters is typically touched only lightly: gender, hobbies, location, occupation, etc'—these are typically touched only lightly, and remain within the same territory. This allows the person to continue the social discussion authentically.

These parameters are more dominant than any of the known and published ones, and therefore require new methods to the specific IM domain. The integration of all of these parameters, possibly with known parameters allow for the new system to succeed in fingerprint generation.

The suggested method for building a fingerprint engine contains the following modules:

a. (preparation) Corpus analysis tool—computes the normal for all gathered parameters;

b. (optional) Personal parameter extraction—training and personalization reference, this module extracts from the given identified text a unique fingerprint of each of the authors;

c. (optional) Learning engine—provides a method for tuning the importance of each parameter. In a preferred embodiment this learning engine is periodically activated to improve the accuracy of the categorization;

d. Fingerprint-storage as well as a fingerprint comparison method—these two allow for rapid comparison of an ‘unseen’ text—against already existing known authors' fingerprints. This storage must support rapid comparison—as the number of authors is in the order of hundreds of millions. (Common hierarchical techniques are used to solve this issue).

e. Adaptation module—as many of the authors are teenagers, their vocabulary and style keeps changing; the method should support incremental update of fingerprints.

In one possible embodiment of the invention upon receiving a text to categorize the system computes its fingerprint vector (term frequency-inverse document frequency). This is a well known word-frequency vector, [WIKI-vector2], and the operations on this vector are well studied. This vector is similar in its structure to the author fingerprint vectors stored in the fingerprint repository. Once the vector is computed a matching operation is computed against some or all of the fingerprints stored in the database. The best fit gets the highest score. If this score is not sufficiently high, the text is categorized as belonging to a new author and a new entity is defined in the fingerprint repository.

One possible example for such a comparison method is a scalar multiplication of the two vectors. However, given the large number of parameters (several tens, some of them are broken into millions of parameters—such as word frequency parameter), and the large number of possible authors (millions), it is suggested that the comparison is performed in a hierarchical fashion—that is authors are grouped according to some distance metrics or in a way which allows for fast probabilistic matching.

In such an embodiment, the learning performed by the learning engine is the “importance” or the weight that each element within the vector receives during the operation; this is in reverse ratio to its frequency in the corpus. The result generates a linear combination of the various parameters, of the form:

ΣaiViUi

where ai stands for the weight of the i-th parameter and Vi and Ui stand for the ith entry of each of the vectors involved, namely the new-text fingerprint vector and the candidate author fingerprint. The result of this operation is normalized to a scalar in the range between 0 and 1. This scalar stands, in the most simplistic description for the probability that the new sample was created by the author represented by the vector V.

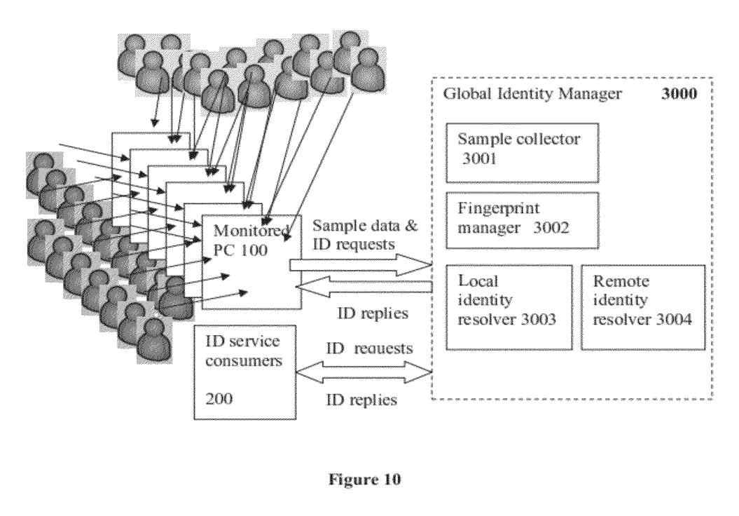

Reference is now made to FIG. 10, where an exemplary possible embodiment of a global identity management system is described. In such an embodiment, each monitored PC (100) or end-device, is equipped with an agent of the identity management system. This agent monitors the virtual identities that are detected on it and transmits the information about user interactions and their samples. It then can issue identification requests (marked as ID Requests). The global Identity Management System gathers the sample data using the sample data collector (3001), and generates for each virtual identity (remote or local) its fingerprint, using the fingerprint manager (3002). This fingerprint manager is comprised of the fingerprint generator, for example, as described with reference to FIGS. 7, 8 and 9. Based on this information, and the fingerprint matching capabilities, the global identity manager can respond to ID requests by either providing a real-life person identity, or returning a virtual identity qualifier for remote identities. (3003 and 3004).

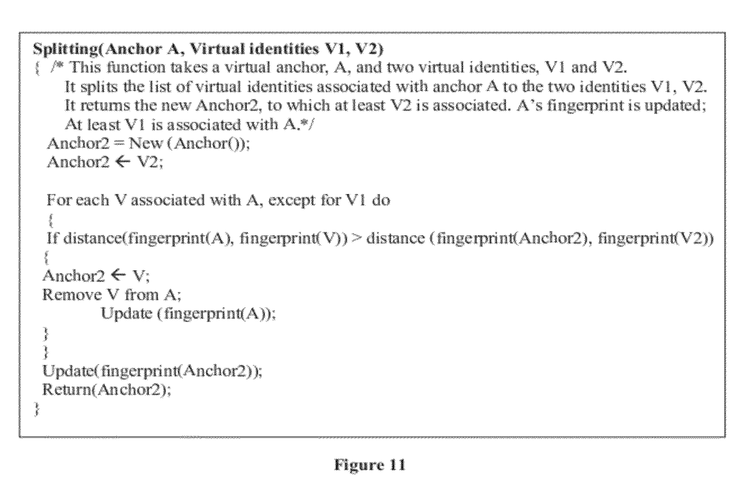

In an exemplary embodiment of the invention, local and remote identity resolution components (3003 and 3004) include a generation process for anchor virtual identities and/or the splitting of previously grouped identities, as described in FIGS. 4.1, 4.2 and 5, and in FIG. 11.

Grouping of virtual identities may take place periodically. In accordance with an exemplary embodiment, however, virtual identities are continuously grouped, for example, as they are inserted to the system, and/or upon an update of a virtual identity fingerprint. In an exemplary embodiment of the invention, a fingerprint is updated when a sufficiently large number of samples are added for a virtual identity. This typically ranges between several Ks of text data when the system encounters a new identity, to 1 Mbyte, for an already known virtual identity. When this amount of sample information, the system updates fingerprint-distance, the two identities are combined into a single anchor. Lists of virtual identities are referred to as anchors. Combining two anchors is simply the combination of the two lists. Combining a virtual identity to an anchor is adding it to the list, and combining two virtual identities is simply creating a list that contains both of them. Fingerprints are updated accordingly: the weighted sum of the fingerprint vectors for each virtual identity set is computed.

If anchors allow for accumulating multiple virtual identities, it may be desirable to support also the reverse operation—that is to split a virtual identity out of an anchor. This may be desired in several cases, for example, one or both of:

1. As the fingerprint is refined—the distance function values get modified, and hence, previously ‘close’ identities, can become far apart.

2. In the case that there is an external evidence that two virtual identities are really two distinct people, although their previously computed fingerprints were rather close (and thus they were associated with the same anchor).

A sample pseudo code for splitting an Anchor A, is shown in FIG. 11. The function takes an anchor A and two “evidences” V1, and V2—two virtual identities which are associated with A, and are candidates to be split apart. At the end of the splitting function, at least V1 is associated with A, and at least V2 is associated with the newly created anchor. The two fingerprints are updated, and the virtual identities are located based on their distance from the anchors.

The evidence for a need for a split of an anchor is often a result of the accumulation of sufficient detailed fingerprint information on two virtual identities which have been, possibly erroneously, grouped together before. It is often the case that a “new-comer” virtual identity, an identity that has just showed up, is relatively similar to an already existing anchor or other virtual identity. Thus this new virtual identity might be associated with the already existing anchor, or a new anchor might be created. With time, as more detailed samples are gathered, as well as operational information is gathered, the two virtual identities signatures become more distinct. At this point the splitting takes place. In addition, a periodic process reviews the anchors and evaluates that the anchors' virtual identity are still within a reasonably small distance between each other.

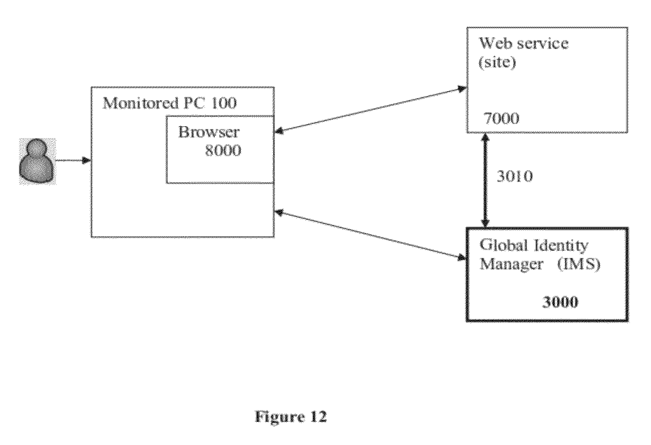

Reference is now made to FIG. 12, which shows a possible block diagram of the use of the IMS for site personalization. Site personalization is a technique of dynamically generating a web-page that suits better the preferences of the viewing user. This allows for achieving higher customer satisfaction and better commercial results.

Using the IMS (3000) as described before, preferably in its global configuration, allows for providing any web-site (7000) that registers for the IMS service to get classification or categorization information that allows for the desired personalization.

The communication 3010 allows for the web-site to transfer the needed identification “key” or sample that would allow the IMS to provide the web-site with either a full unique identification of the “current-user”, or to provide the association of the current-user to at least one of a set of predefined categories. For example, the user age is between 12 and 15 years old, or the user's gender is female.

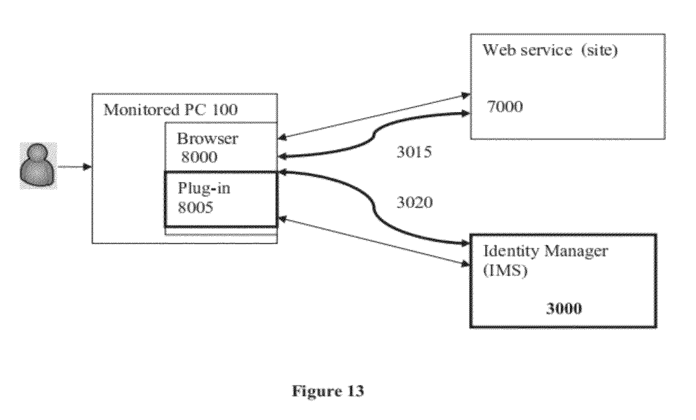

FIG. 13 shows an alternative embodiment of the IMS for site personalization. In this figure, there is no direct communication between the web-site 7000 and the IMS 3000. Instead, the communication is routed through the user's PC. In the example of FIG. 13 the IMS monitoring part is implemented as a plug-in (8005) within the browser. Plug-in technology is commonly used in various applications; see for example [PLUGIN-1]. Such a plug-in allows for communication with both the web-site 7000 through extending the browser-site communication via a dedicated communication 3015 which is directed by the browser 8000 to the plug-in 8005, which then transmits the desired information to the IMS 3000 using a built-in communication 3020. Such a configuration allows for transmitting the site requests to the IMS, which then responds with information as before of either unique identification information or categorization information that is sufficient to support the web-site personalization.

Embodiments of the current invention can also be used for extending and refining access-control and filtering of information;

In some embodiments of the current invention the user-identification system is included in the monitoring system; in yet other embodiments of the invention also the filtering and the access control are embedded within the system. In yet another embodiment of the system the user-identification and the filtering and policy enforcing modules are combined.

Embodiments of the present invention allow for refining user identification based on the actual real-life user behavior that operates the computer, rather than based on assumptions about operating-system password or even biometric methods. Accordingly, in some embodiments of the invention the system can be used as an on-going user validation mechanism.

In some embodiments of the current invention, the policy enforcement module can be a security service, access control service, or other services that need to be aware of the current user operating the computer.

It is expected that during the life of a patent maturing from this application many relevant systems and methods will be developed and the scope of the term computing units, servers, and networks is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format to is merely for convenience and brevity and should not be construed as an inflexible limitation on the scope of the invention. Accordingly, the description of a range should be considered to have specifically disclosed all of the possible sub ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all of the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or to identification of any reference in this application shall not be construed as an admission that such reference is available as prior art to the present invention. To the extent that section headings are used, they should not be construed as necessarily limiting.

### REFERENCES

[1-LDAP] http://en.wikipedia.LDAP
[1-smartcard] http://www.smartcardalliance.org/pages/smart-cards-applications-identity
[1-OracleIDM] http://www.oracle.com/technetwork/middleware/id-mgmt/overview/index.html
[1-bio] http://www.ehow.com/list_{—}7224048_biometric-typing-characteristics.html
[2-bio] http://www.findbiometrics.com/
[1-dev_rep] http://www.iovation.com/
[2-dev_rep]http://www.the41.com/
[MS-5] http://msdn microsoft.com/en-us/libraray/ms632589%28v=vs.85%29.aspx
[TCP-1] http://wWww.nirsoft.net/utils/smsniff.html
[TCP-2] http://www.cyberciti.biz/faq/tcpdump-capture-record-protocols-port/
[WIKI-1] http://en.wikipedia.org/wiki/Keystroke_logging
[WIKI-vector2] http://en.wikipedia.org/wiki/Vector_space_model
[PLUGIN-1]—http://en.wikipedia.org/wiki/Plugin

1. A method of generating an automatic response to a user-application interaction, comprising:
providing a list of a plurality of defined users, each said defined user being associated with at least one response to a user-application interaction of a respective said defined user with one of a plurality of defined applications accessible via a client terminal;
identifying a current user of said client terminal from said plurality of defined users and at least one current interacted application from said plurality of defined applications;
selecting a respective said at least one response according to said at least one current interacted application and said current user; and
triggering said respective at least one response.

2. The method of claim 1, wherein said identifying comprises performing an analysis of at least one of a plurality of user-application interactions, made with said client terminal and identifying according to said analysis.

3. The method of claim 2, further comprising transmitting said at least one response to said client terminal to trigger a response to said plurality of user-application interactions.

4. The method of claim 2, wherein said at least one response comprises sending a notification indicative of at least one of said plurality of user-application interactions to a preset address.

5. The method of claim 2, wherein said analyzing comprises indentifying a remote communicating partner participate in at least some of said plurality of user-application interactions; said selecting being performed according to said remote communicating partner participate.

6. The method of claim 1, wherein said at least one response comprises instructions for authenticating an instant messaging session.

7. The method of claim 1, wherein said at least one response comprises instructions for enforcing at least one of a parental control function and security policy function.

8. The method of claim 1, wherein said at least one response comprises instructions for disconnecting said client terminal from an ongoing communication session.

9. The method of claim 1, wherein said method is performed from a first network node and while said client terminal is a second network node.

10. A method of identifying a unique identity of a user, comprising:
analyzing a plurality of user-application interactions, made on a client terminal, to identify a plurality of behavioral user interaction signatures; and
associating each said behavioral user interaction signature with another of a plurality of unique users.

11. The method of claim 10, further comprising:
monitoring said client terminal to intercept at least one current user-application interaction; and
instructing said client terminal according to a match between said at least one current user-application interaction and one of said plurality of behavioral user interaction signatures.

12. The method of claim 10, wherein said analyzing comprises indentifying a plurality of virtual identities of each said unique user according to said behavioral user interaction signatures.

13. The method of claim 10, wherein said analyzing comprises indentifying at least one of a biometric feature and a linguistic feature of at least one of said plurality of unique users.

14. The method of claim 10, wherein said analyzing comprises indentifying spelling mistakes of at least one of said plurality of unique users; wherein said associating is performed according to said spelling mistakes.

15. The method of claim 10, wherein said analyzing comprises indentifying emoticons used by at least one of said plurality of unique users; wherein said associating is performed according to said emoticons.

16. The method of claim 10, wherein said analyzing comprises indentifying typing speed of at least one of said plurality of unique users; wherein said associating is performed according to said typing speed.

17. A method of identifying a user of a client terminal, comprising:
gathering information pertaining to a participation of a user of a client terminal in a social messaging (SM) session to extract at least one SM communication pattern;
identifying a match between said at least one SM communication pattern and at least one of a plurality user profiles each defining at least one user characterizing SM communication pattern; and
outputting said at least one user profile.

18. The method of claim 17, further comprising identifying said user as a child or an adult according to said at least one user profile.

19. The method of claim 17, further comprising:
forwarding said at least one user profile to a human operator for a review; and
allowing said operator to determine, according to said aid at least one user profile, how or if to intervene in said SM session.

20-27. (canceled)

28. The method of claim 17, further comprising:
selecting at least one personalization rule for adjusting a web page accessed by said user according to said at least one user matched profile; and
personalizing said web page according to said at least one selected personalization rule.

29-37. (canceled)
